(19) United States
(12) Patent Application Publication
(10) Pub. No.: US 2003/0110228 A1
(43) Pub. Date: Jun. 12, 2003

(54) Method and apparatus for monitoring activity and presence to optimize collaborative issue resolution

(76) Inventors: Ziqiang Xu, Mountain View, CA (US); Dean Yu, Mountain View, CA (US); Michael W. Kelley, Saratoga, CA (US)

Correspondence Address: Kenyon & Kenyon, Suite 600, 333 W. San Carlos Street, San Jose, CA, 95110, US

(21) Appl. No.: 10/025,373

(22) Filed: Dec. 17, 2001

Related U.S. Application Data
(60) Provisional application No. 60/340,326, filed on Dec. 12, 2001.

(51) Int. Cl. G06F 15/16

(52) U.S. Cl. 709/207; 709/224

(57) ABSTRACT

A collaboration workspace for multi-party resolution is presented that monitors activity and presence to improve communication and enhance the ability of service providers and users to work together to resolve issues concerning a user request or trouble ticket. Depending on the status of the user and service provider (e.g., offline, active, busy, etc.), the communication window provides communication in an E-mail or instant-messaging format.

### BACKGROUND OF THE INVENTION

The present invention pertains to a method and apparatus for tracking the location of users within a collaborative issue resolution system, and monitoring users' activities on objects, such as a user request or trouble ticket, within that system. More particularly, the present invention pertains to the use of presence and activity information to optimize the collaborative issue resolution process involving two or more parties, especially pertaining to finding and engaging the necessary resources to resolve the user request, and optimizing how the involved parties communicate with each other.

In the computer industry, users rely heavily on computer hardware and the software that is being executed by the hardware. For example, when a software application is released to the public, the developer must provide user support when different technical questions, such as problems with the software application or how-to questions about the software are raised by the user. Similarly, for system software and computer hardware (including main computer hardware such as the memory or the disk drive) and computer peripheral hardware such as a printer, mouse, a keyboard or a scanner, the developer of that system software or computer must also provide user support to answer the user's technical questions.

The user support of a software application, system software or hardware, however, is very costly and time consuming. For a typical company, the user support of a software application may be a group of “experts” who listen to the user's technical questions and complaints and attempt to solve the user's technical questions by following a script of potential solutions. These experts may include internal or external resources. The cost of maintaining this group of user support people is enormous. In addition, support people cannot possibly know the answer to every technical question that a user asks and therefore, often end up with low satisfaction ratings. Often, a single support person cannot answer the question by themselves, and as a result, organizations may need to marshal many different types of external resources with different levels of expertise such as partners, developers and even other customers in an effort to efficiently resolve an issue. However, it is difficult and costly for organizations to find and communicate with the other experts needed to collaboratively answer the question. The process may be frustrating to both the user and the support personnel. In addition, support people cannot possibly remember all of the prior solutions to the technical questions they see infrequently, and often get bored with repeatedly answering common technical questions. For a user that has a technical question, the user often does not know whom to call to resolve the technical question, waits on hold a long time to get the technical question answered and, even after waiting on hold receives poor or inaccurate advice. The company that seeks to provide technical support for its products may contract with third-party service providers so as to avoid hiring its own technical staff. However, doing so creates additional problems related to control, contract terms and quality.

It is clear that companies face many technology related challenges, from the rapid proliferation and adoption of diverse new technologies to recruiting and retaining IT staff, to managing in-sourced and out-sourced services, to supporting a global and diverse workforce. These companies must ensure that the computer systems, networks and applications they rely upon are efficiently managed and supported by knowledgeable and experienced IT professionals, external service companies and technology vendors. Such companies may have made large investments in CRM helpdesk software, but this software may only be able to route service requests within the boundaries of the company's internal support organization.

One proposal to improve the servicing of user requests is to provide assistance over the Internet or other network system. In one such system, a user creates a service request and submits it to a general set of service providers (preferably under the control of a central system such as a network server for example). One or more service providers can then provide assistance “on-line” to the user. An advantage of such a system is that personnel resources of the software/hardware vendor may be spared when the assistance is provided by a third-party service provider (e.g., compensated by the vendor and/or the user). Though a vast improvement to the call-in centers provided by the software/hardware vendor, there is a need to improve the use of a network system to service user requests.

### SUMMARY OF THE INVENTION

According to an embodiment of the present invention, a system is presented for improving communication and creating a more efficient process through collaboration within and across organizational boundaries in the servicing of a user request. The system includes a mechanism to share the details of specific user requests among the different collaborators. The system includes a first computer system associated with a user that includes a display unit to display a first window associated with the user request. This first computer system is further adapted to transmit and receive messages associated with the user request. With the first computer system, a user is able to submit and resolve user requests. A second computer system is provided that is associated with a service provider; the second computer system includes a display unit to display a second window associated with the user request. The second computer system is further adapted to receive the message and display the message in the second window at the second computer system. This second computer system is also adapted to transmit messages associated with the user request. The second computer system can be adapted to provide displays to assist the service provider in finding user requests, resolving them, and finding and engaging collaborators to work on the user request(s). Such a second computer system may be provided for each service provider that is working to resolve user requests. A third, or central, computer system can be provided (e.g., one or more servers) coupled to the first and second computer systems to serve as a network platform. Using this system, a user and a service provider are better able to communicate with each other with respect to servicing a user request.

The present system improves the servicing of user requests by providing a way to collaborate within and across organizational boundaries on specific user requests using the Internet or other network system. In one embodiment, a user creates a service request and submits it to a general set of service providers (preferably under the control of a central system such as a network server for example). One or more service providers can then provide assistance “on-line” to the user. An advantage of such a system is that it allows organizations to build a collaborative support organization that includes people inside the support team, throughout the company, and also external partners with the appropriate skills. Another advantage of such a system is that personnel resources of the software/hardware vendor may be spared when the assistance is provided by a third-party service provider (e.g., compensated by the vendor and/or the user). Moreover, because it enables an extended team of experts to work together to resolve issues, such a system results in greater efficiency and cost-effectiveness which leads to overall improved quality and satisfaction.

Because presence information can be maintained by the system, providers working on an issue can see whether fellow collaborators are logged in, whether they are working on the user request in question or another issue. Also, providers can maintain a list of “favorite collaborators” and invite individuals on this list to help on a user request based on their presence status or activity level. Furthermore, a manager can log into a management console and see what issues the team is working on.

### BRIEF DESCRIPTION OF THE DRAWINGS

FIG. 1 is a block diagram of a system for handling user requests and communication between a service computer and a service provider computer constructed according to an embodiment of the present invention.

FIG. 1a is an example of a display screen for a service provider to select a user request according to an embodiment of the present invention.

FIG. 2 is an example of a display screen for a user computer according to an embodiment of the present invention.

FIG. 3 is an example of a display screen for a service provider computer according to an embodiment of the present invention.

FIG. 4 is a flowchart for assigning an Active Level for a trouble ticket according to an embodiment of the present invention.

FIG. 5 is schematic diagram showing the interaction of modules pertaining to presence information in the system of FIG. 1.

FIG. 6 is a state diagram for handling the loading and unloading of presentity objects according to an embodiment of the present invention.

FIG. 7 is a schematic diagram showing the interrelationship between the Watcher modules, presence service module and display according to an embodiment of the present invention.

FIG. 8 is a schematic diagram showing the interrelationship between a client and the server according to an embodiment of the present invention.

FIG. 8a is a block diagram showing the interrelationship between a primary and secondary service provider as it relates to ownership according to an embodiment of the present invention.

FIG. 9 is an example of a display screen for a service provider to request collaboration according to an embodiment of the present invention.

FIGS. 10a-d are examples of display screen for controlling features of collaboration in servicing user requests according to an embodiment of the present invention.

### DETAILED DESCRIPTION

According to an embodiment of the present invention, a service network platform is provided connecting user computer systems with service provider computer systems. Under the control of the service network platform, the presence of the users and service providers is monitored, allowing service providers and users a better opportunity to resolve user requests directly. The monitoring of presence information can also lead to an improved basis for collaboration between service providers in resolving user requests.

The present invention will be described with reference to a network system. In one embodiment, the network system is the Internet, but the present invention can be extended to other types of network systems including local area networks (LANs), wide area networks (WANs), Intranets, etc. Broadly, the present invention concerns the servicing of service requests (also referred to herein as “user requests” and “trouble tickets”) submitted by users or by systems on behalf of users. In this embodiment, an agreement exists between the user and the service provider to provide information as to how to address a user request. For example, if a user is having trouble getting a software program to load on his/her computer, the user can submit a user request and a service provider agrees to service that request for a fee paid by the user. The user request will include a description of the problem he/she is having and a description of the hardware/software being used.

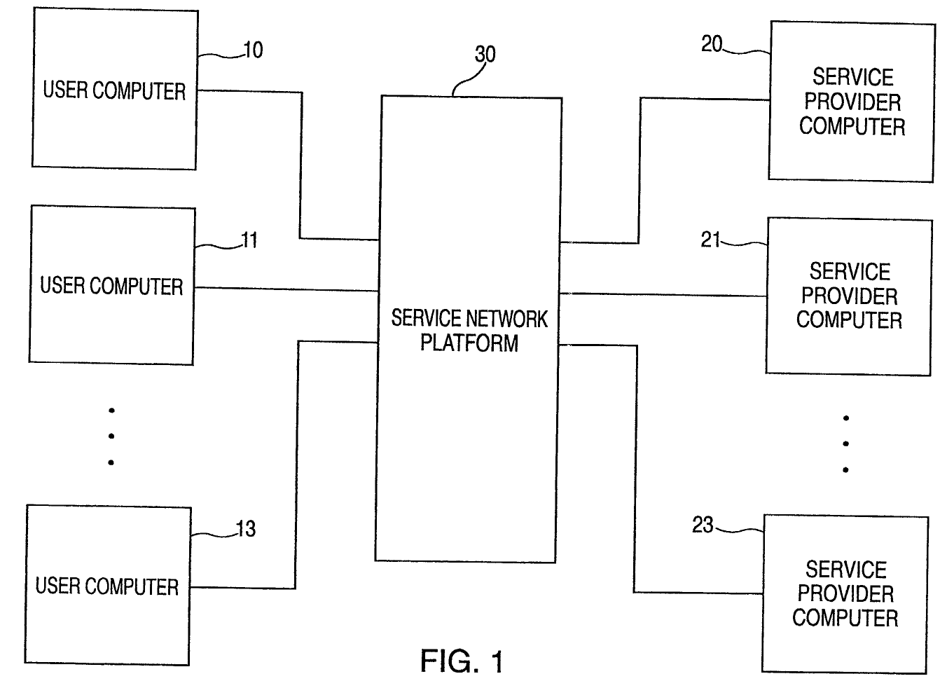

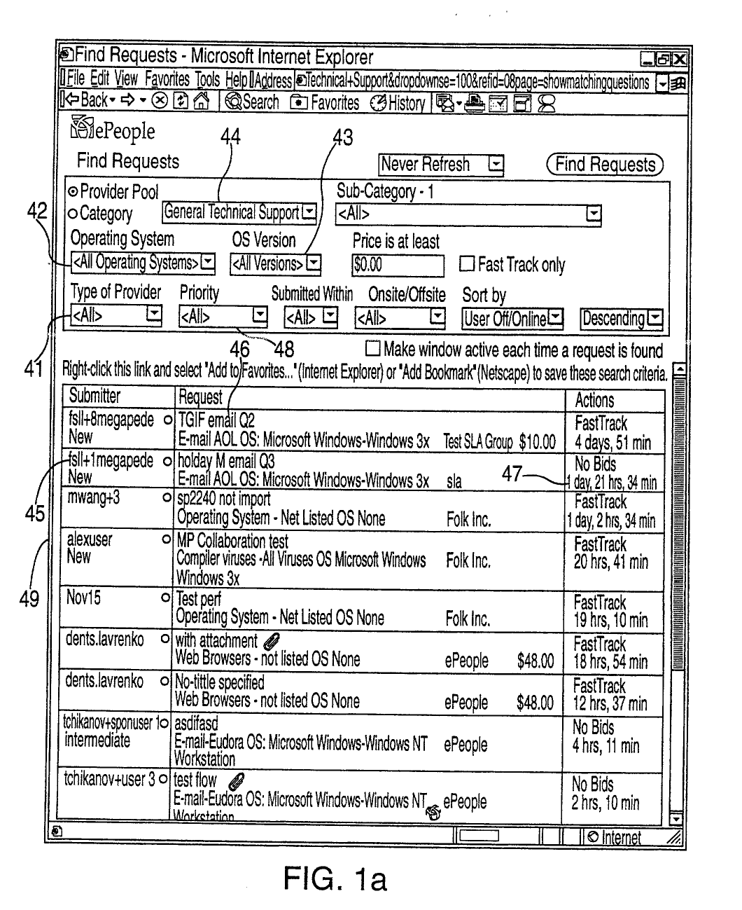

Referring to FIG. 1, a block diagram of a network including a system of the present invention is shown. In the network system, a plurality of user computer systems may be provided (e.g., user computer 10, 11, . . . 13) coupled to the network. In this embodiment of the present invention, a user will send a request (i.e., a user request or trouble ticket) to the service network platform 30 for servicing.

In this embodiment, user computer systems are general purpose personal computers including one or more processors to execute instruction code stored in a storage media such as a hard-disk drive, Compact Disc-Read Only Memory (CD-ROM), or the like. One skilled in the art will appreciate that the present invention can be expanded to a variety of other computer systems (e.g., those operating over a local network) or electronic communication systems (e.g. two-way pagers, hand-held devices, etc.).

Referring to FIG. 1, one or more user computers 10 (e.g., personal computers coupled to the Internet) are in communication with a service network platform 30 (e.g., a server coupled to the Internet). In this example, the user operating user computer 10 may have a service request that he/she would like resolved through the system of the present invention. In this embodiment, the user 10 transmits service requests to the service network platform 30 as a trouble ticket. The trouble ticket can include a category of the service request he/she desires to be resolved. In this embodiment, those categories include software, hardware, administration, telephone, output, storage, hosting, and others. Though the present invention is described with respect to handling service requests concerning computer problems, the present invention should not be so limited.

For computer problems, in addition to a category, the user may enter a title for the service request along with the operating system for his/her computer, the amount of random access memory in the user's computer, the user's level of knowledge in the problem area, a description of the service request, the native language of the user, and the priority of the request. Other information may be made an automatic part of the user request, such as diagnostic data for the user computer. For example, the type of processor being used, the software programs loaded on the user computer, etc. can be determined without user intervention in a known manner and included with the user request to assist an eventual service provider.

The user request is eventually accessed by one or more service provider computers 20, 21, . . . , 23. In this embodiment, an agreement is created between a user at a first computer (e.g., computer 10) and a service provider at a second computer (e.g., computer 20) via the service network platform 30. Efficient matching of requests to providers is important. Efficiency is increased by filtering requests to show a service provider only appropriate requests, and by displaying information about the requests to facilitate the provider's request selection. Examples of data that can be used for request filtering and request display are: title, description, classification, custom parameters defined by the customization of a request template (e.g., the template used to enter a user request), whether the user is online, whether the request requires an initial provider, whether the request requires a collaborating provider, whether collaborating providers are online, provider skills, provider certifications, service level agreement terms (e.g., the contract terms between the service provider(s) and user for servicing the request), payment for responding to the request, payment for resolving the request, whether the provider can see requests matched to other providers, what extra tools are available to help resolve the request, the user's preferred communication medium, what types of issues the provider has successfully collaborated on in the past, what information the provider has provided to similar requests before, the prior ratings the provider has received from users or other providers, etc. Similarly, when matching is performed by having the provider bid on requests, information may be displayed to the user to facilitate their choice of provider, for example provider skills, rating, experience, price, past example user request, company affiliation, etc.

Referring to FIG. 1a, an example of a display for selecting a user request at a service provider computer is shown. In this embodiment, the screen includes a search-entry field 41 and a request-list field 49. In the search-entry field, a service provider is able to enter search terms (e.g., via predetermined pull-down menus) to filter the number of pending user requests. For example, the service provider can search based on operating system 42, the version of the operating system 43, the classification of the user request 44, etc. Those user requests that satisfy the search terms in the search-entry field 41 can then be displayed in the request-list field 49. In this embodiment, the information displayed on each user request includes an identifier of the person making the request 45, a title for the user request 46, competitive offers for service 47, user priority for the user request 48, etc. After selecting a user request, a service provider can enter into a contract to service the request as described above.

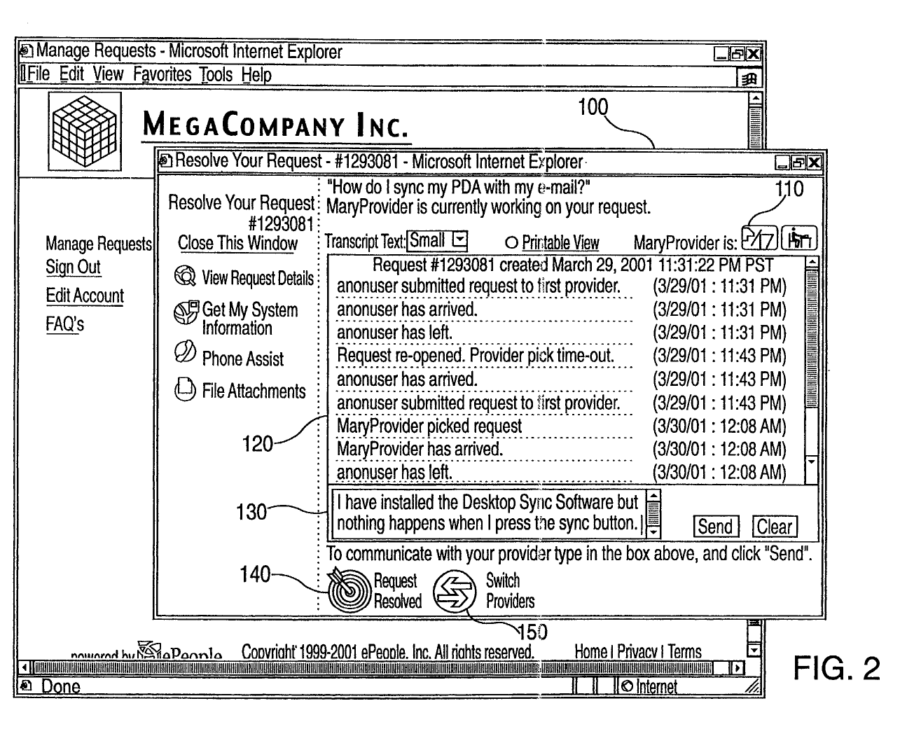

According to an embodiment of the present invention, an integrated display is created at the user computer 10 and the service provider computer 20 to facilitate communication between the parties concerning the user request. Referring to FIG. 2, an example of a display at a user computer is shown. This display can be referred to herein as a unified messaging or collaboration workspace window in that a plurality of information for the user request may be presented in a single window. In this embodiment, the display window 100 includes a presence area 110 that indicates presence information for the service provider (i.e. senses when users are logged in and is described in more detail below); a transcript area 120 that includes a list of messages transmitted between the user and the service provider; and a messaging window 130 that allows the user to type a text message to be sent to the service provider. The display window may also include “buttons” that allow the user to indicate that a user request has been resolved (button 140) or to request that the user request be switched to a different service provider (button 150). To identify the user request, a request number (e.g., as indicated in the messaging window 130) and title may be used. As seen from the contents of the display window 100, the transcript area 120 and messaging window 130 are associated with the identified user request. Accordingly, the information relevant to the servicing of the user request is present in a coordinated manner (especially if the user and/or service provider is dealing with multiple user requests).

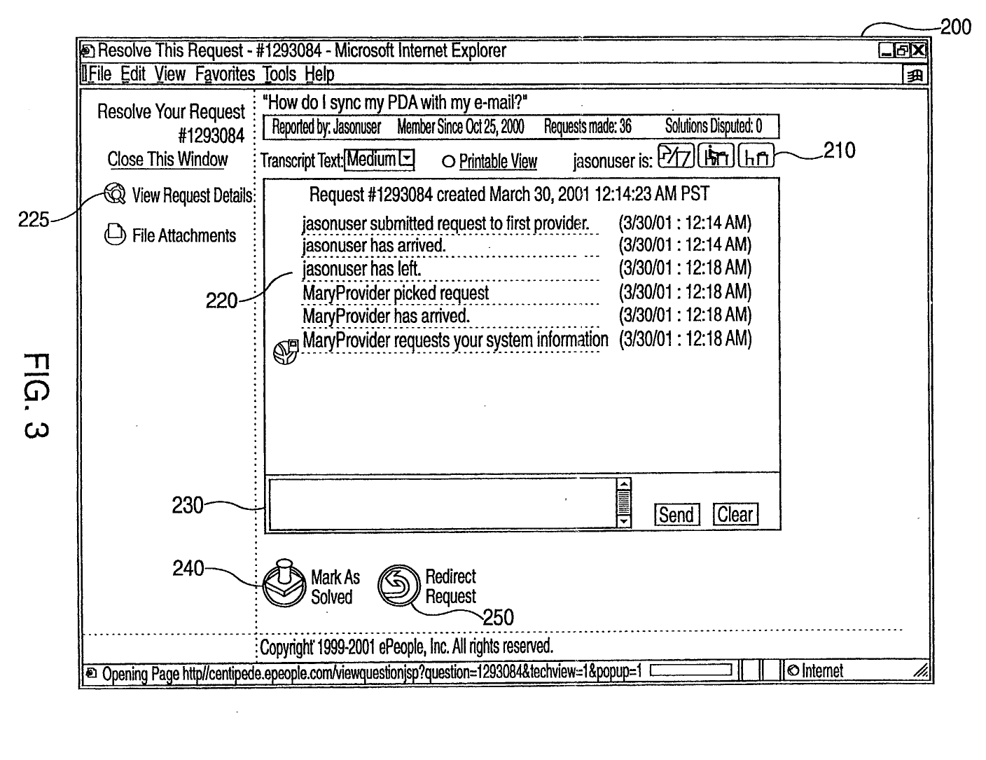

Referring to FIG. 3, a second display window 200 is presented for a service provider according to an embodiment of the present invention. According to this embodiment of the present invention, the display window 200 includes similar areas when compared to display window 100 (FIG. 2). Display window 200 also includes a presence area 210 that indicates presence information for the user (described in more detail below); a transcript area 220 that includes the list of messages transmitted between the user and the service provider; and a messaging window 230 that allows the service provider to type a text message to be sent to the user. In the service provider display window, a first button 240 is provided to indicate that the user request has been solved (in the opinion of the service provider) and a second button 250 to redirect the user request to another service provider.

In operation, each text message entered into the messaging window 130 will be displayed as an entry in the transcript window 120 and will be received by the service provider and displayed as an entry in the transcript window 220. Likewise, text messages typed in messaging window 230 are transmitted to the user and displayed as entries in transcript area 120. Based on the presence information available in areas 110 and 210, the user and service provider are able to communicate in one or two ways: 1. In an E-mail format, where each text message is responded to when the other party checks for messages; and 2. In an instant messenger format, where each text message sent is reviewed by the other party soon after it is received.

As stated above, presence information may be presented to the user and/or service provider as to the other party. In this embodiment of the present invention, a user can have one of two presence states: online and offline, where online indicates that the user is logged into the service network platform (element 30 in FIG. 1). Also in this embodiment, the service provider can have one of several presence states: online/active, online/inactive, and offline (if desired the same presence states may be maintained and displayed for the user). When online/active, the service provider is logged into the service network platform and has the display window for the user request in question on his/her screen. Using presence information, the user is able to know if the service provider working on the user request is available for instant-messaging type communication or E-mail type communication.

Presence information can be retrieved and reported in any of a variety of known manners. In one embodiment, presence information is controlled by a plurality of modules running at the service network platform as well as the service provider computer and the user computer. The user request, or trouble ticket, also has presence information associated with it in this embodiment. For example, when there is no communication between the user and the service provider, the trouble ticket could be referred to as inactive. If there is communication occurring frequently between the user and the service provider, then the trouble ticket could be referred to as hyperactive. In this embodiment of the present invention, it is desired to make sure that communication concerning a hyperactive trouble ticket is given priority at the service network platform over communication concerning an inactive trouble ticket.

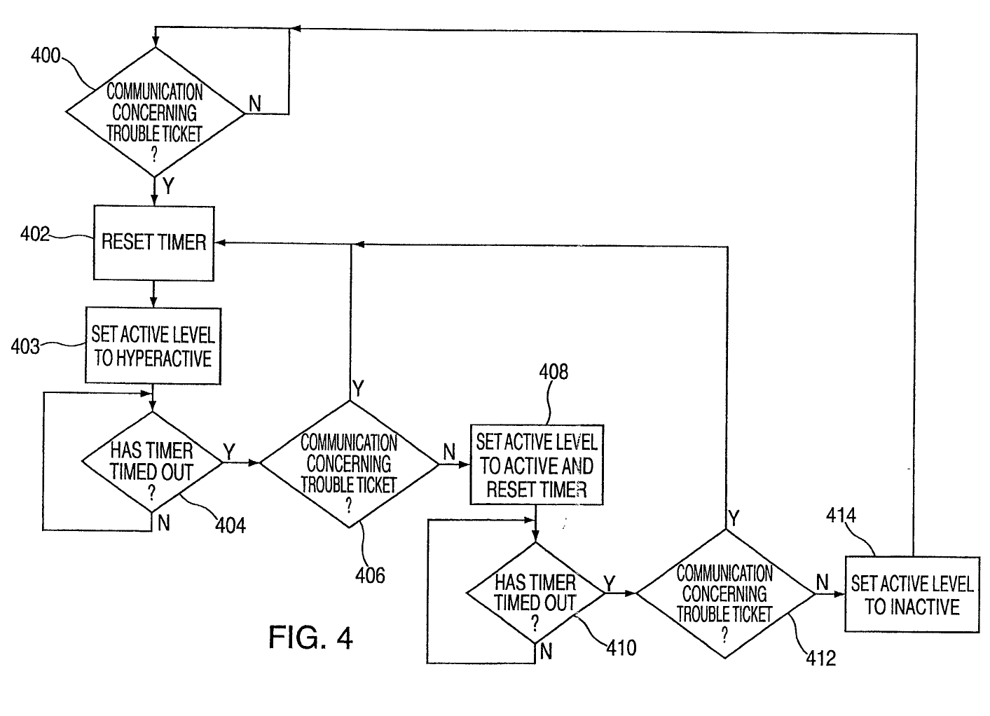

A level of activeness can be denoted based on a timeout counter. Referring to FIG. 4, a flow diagram for the designation of a level of activeness for a trouble ticket is shown. In decision block 400, it is determined whether a communication has occurred for a given trouble ticket (e.g., identified by an ID number or the like). Once a communication occurs, a timer associated with the trouble ticket is reset (block 402) and the Active Level for the trouble ticket, used to determine optimal screen refresh rates, is set to Hyperactive (block 403). In decision block 404, it is determined whether the timer has timed out (in this embodiment, the timer is two minutes in duration). If it has, then control passes to decision block 406 where it is once again determined whether there has been a communication during the count of the timer for the particular trouble ticket. In decision block 406, it can also be checked to see if the user and service provider are both logged into the service network platform. If there has been communication, then control passes back to block 402 and the timer is reset. If there has been no communication, then the Active Level is changed to a middle level, “Active,” and the timer is reset (block 408). Control passes to decision block 410 to wait for the timer to time out. When it does, control passes to decision block 412 to determined whether a communication concerning the trouble ticket has occurred during the count of the timer. If there has, then control passes to block 402 to reset the timer and set the Active Level to “Hyperactive” again. Alternatively, if desired, the Active Level can stay “Active” if the user and service provider are still logged on. If there has been no communication, then the Active Level for the trouble ticket is set to “Inactive,” (block 414) and control passes back to decision block 400. In this way, the Active Level minimizes the latency between the time updates on the trouble ticket and the time updates that are delivered to the web screens for the user and the service provider; and, thereby, traffic and the load to the central server are diminished.

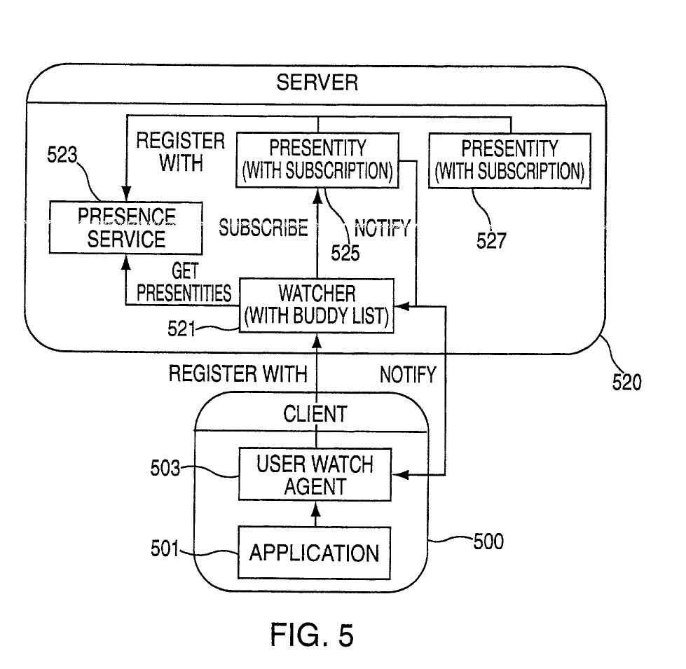

With presence information defined for the user, service provider, and trouble ticket, the following discusses the use of programming modules to monitor and report presence information according to an embodiment of the present invention. Referring to FIG. 5, a block diagram showing the relationship between a client 500 and a server 520 is shown. In this embodiment, the client 500 includes a general application 501, which provides a user interface for the user, for example. The general application 501 interacts with a User Watch Agent 503, which controls the receipt and transmission of presentity information with the server 520. In this embodiment, the User Watch Agent 503 registers with a Watcher module 521. In registering, the User Watch Agent can report presentity information for the person at the client 500 and can indicate which presentity information it would like to be current with. For example, if a user is at client 500, then he/she would register with Watcher 521 so that his/her presentity information would be reported to server 520 and would want updates as to the presentity information for his/her user request and the service provider that is servicing it. Likewise, a service provider would register with Watcher 521 so that his/her presentity information would be reported to server 520 and would want updates as to the presentity information for the user requests he/she is working on and the presentity information for the users associated with these user request.

The Watcher module 521 can store a “Buddy List” of favorite collaborators for each user and service provider. For example, a particular user would have a buddy list associated with him/her that lists the user requests, he/she has submitted, and the service providers working on them. The Watcher module 521 communicates with a Presence Service module 523, which accepts, stores and distributes presence information. Each presentity to be monitored registers with the Presence Service module 523 (e.g., presentities 525 and 527). When presentity changes for a user, service provider, user request, that information is supplied by the presentity to the Watcher module 521 in the server 520 and the user Watch Agent 503 at the client 500.

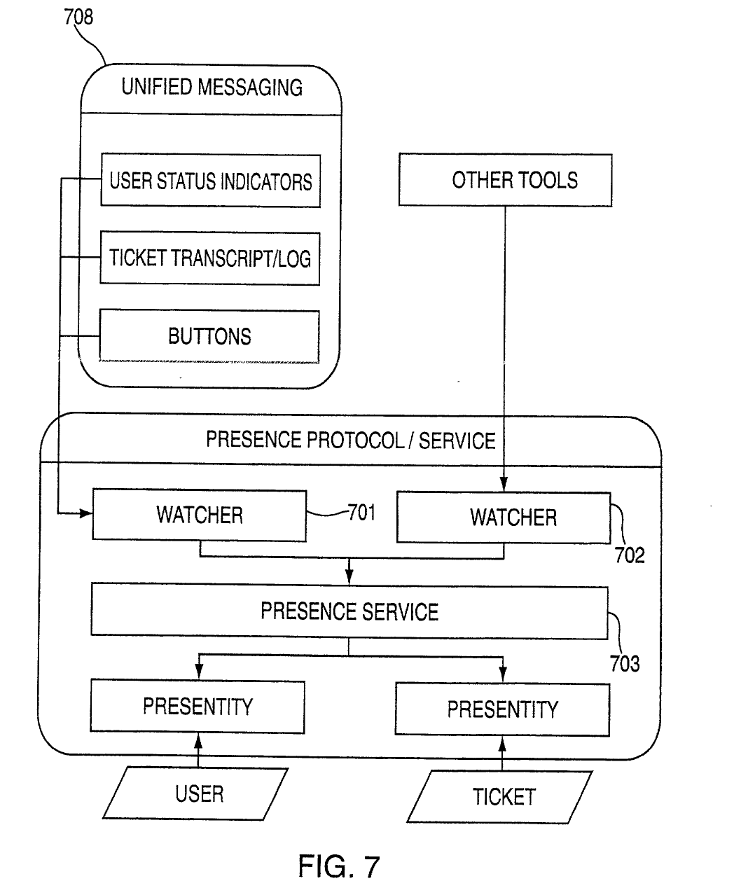

Referring to FIG. 7, a schematic diagram showing the interrelationship between the Watcher modules, Presence Service module and display is shown. In FIG. 7, the Watcher modules 701, 702 are coupled to a Presence Service module 703. The Presence Service module, in turn is coupled to presentity objects 704, 705, which receive input from a user and a trouble ticket (as discussed in more detail below. In this embodiment, Watcher module 701 receives input from a variety of items present in the collaboration workspace display 708 including user status indicators (e.g., offline, active, etc.), ticket transcript/log (e.g., the transcript area), and buttons (e.g., those that indicate that the trouble ticket has been closed or transferred). In addition to those features in the messaging window, inputs from other tools can be monitored by Watcher module 702, for example (e.g., whether desktop sharing has taken place between the user and the service provider).

As indicated above, the service provider, user, and trouble ticket each have various presence states. The system of FIG. 1 can keep track of more states than are reported in the displays of FIGS. 2 and 3. For example, each user and service provider can have the following presence states: offline (i.e., not logged into the service network platform); away/inactive (i.e., logged in, but has been inactive for a predetermined amount of time, such as five minutes); busy (i.e., logged in, but active with a different user request); and free (i.e., logged in, and active with a particular user request). To maintain manageability of the system of FIG. 1, each presentity to be monitored includes a presentity object. Whether this object is maintained or removed depends on: 1. whether the principal behind the presentity object (i.e., the user, provider) is logged onto the service network platform, and 2. whether there are subscribers of the presentity object.

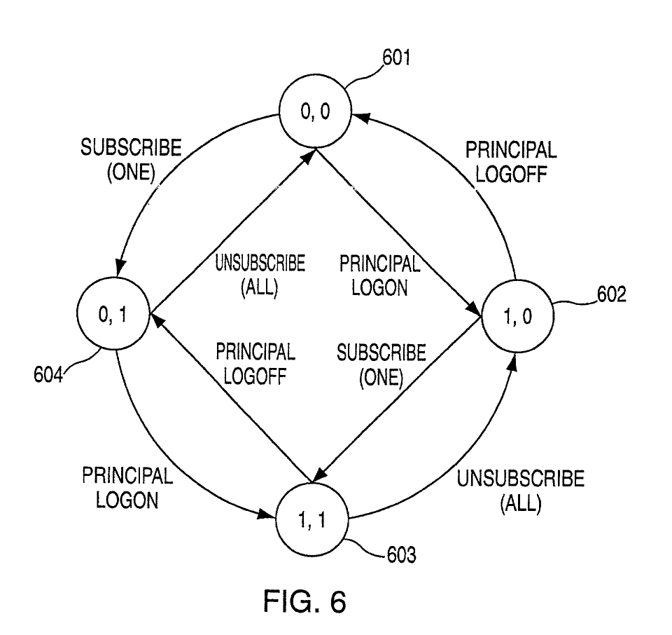

Referring to FIG. 6, a state diagram showing the handling of presentity objects is presented. In this embodiment, the first state variable is an indication as to whether the principal is online (1) or offline (0), and the second state variable is an indication as to whether there are subscribers to the presentity information of a presentity object. In FIG. 6, the reset state is state 601 where the principal is not logged in and the object has no subscribers. When the state changes from 601 to 602 or 604, a presentity object needs to be loaded and when the state changes back to state 601, the presentity object needs to be unloaded. In loading a presentity object, it is maintained by the presence service module 523 (FIG. 5) and can be accessed for status and updates as needed by Watcher modules in the system.

In addition to user and service provider presentity, ticket presentity can also be maintained. It can be maintained simply as an open question (i.e., unresolved user request being worked on by the service provider and user) or a closed question (i.e., no further work is to be done for the user request). It can also be maintained in a more elaborate manner to indicate where in the context of solving the user request, the request is at. Each ticket presentity can include a ticket transcript object, which holds all ticket log entries for the ticket. Thus, as each event occurs for a ticket (e.g., a communication from the user to the service provider), that event can be logged to the corresponding ticket presentity, and then the log entries can be dispatched to the subscribers (e.g., after notifying the appropriate Watcher modules). Thus, as with the user and service provider presentity information, the ticket transcript object is only loaded when a subscriber to the ticket is logged on. By keeping track of events, the ticket transcript object can be used to make sure that a subscriber has seen all events for the ticket. Thus, when the user logs into the system, for example, the events not seen by the user can be loaded quickly for him/her. Alternatively, the user can be E-mailed when events occur to his/her trouble ticket if desired. The presentity information may affect what events cause E-mail notifications, for example E-mail notifications of request updates are not sent if the user is online and viewing the request. Request state is also used to optimize screen updates, e.g. refreshing only sections of the computer screen that can change in the current ticket state, or controlling what tools or workflow user interface elements are displayed to the user and provider

The Watcher module is created by a user or service provider to watch the presentity for users/service providers/tickets having presentity information. In this embodiment, the Watcher module keeps track of all presentities that it is subscribed to. In addition, the watcher module can also keep a database of all presentity changes that have occurred since the last time the subscriber has checked the Watcher module.

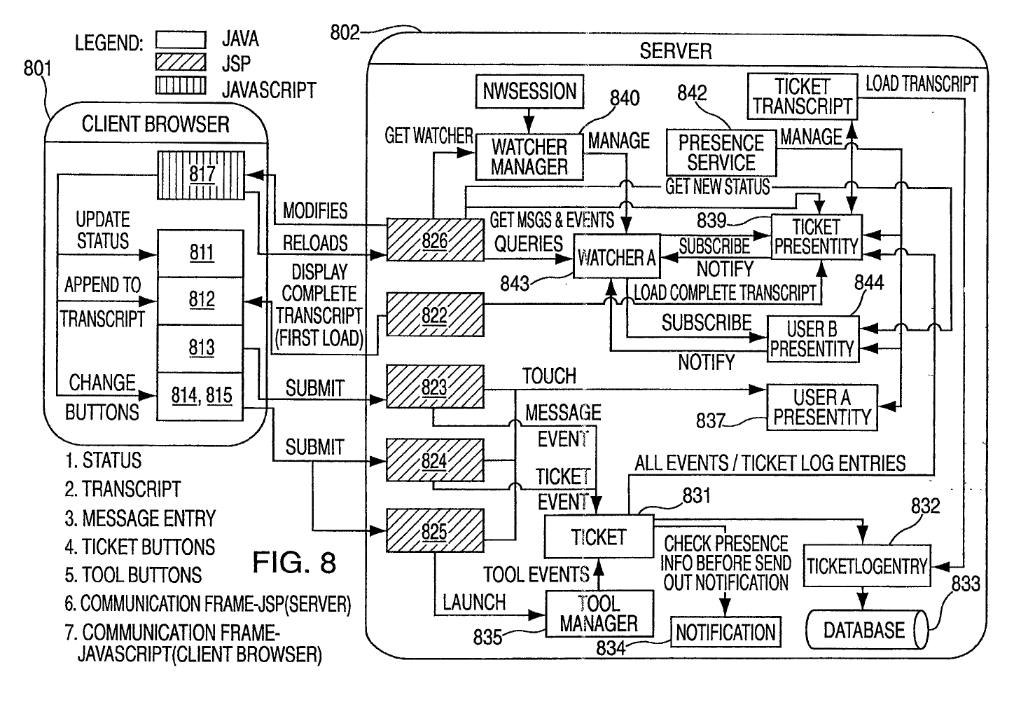

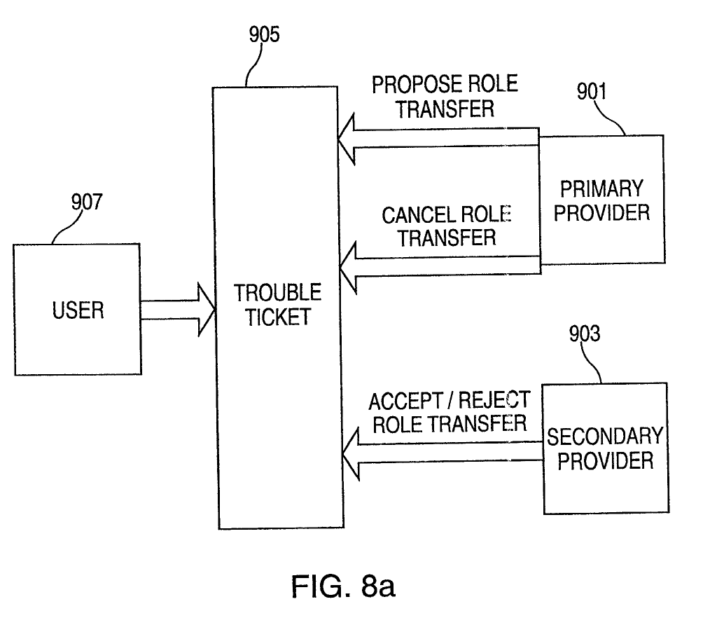

Referring to FIG. 8, a block diagram showing the interaction of the collaboration workspace window with the program modules of a server is shown. In FIG. 8, the client browser 801 includes a communication frame 817 (e.g., implemented using JavaScript) that receives commands to modify the display for the user and transmits requests to reload the information for the screen. The modification data can be supplied as updated status information to module 811, transcript additions to module 812, and button change information to modules 814 and 815. In this embodiment, module 814 handles buttons concerning the status of the trouble ticket and module 815 handles “tool” buttons (e.g., buttons concerning the use of tools, such as desktop sharing). Modules 811-815 can be implemented using the Java programming language.

At the server 802, module 824 receives ticket button entries and forwards that event to a Ticket module 831. Ticket module 831 makes sure that a log entry is made (i.e., at TicketLogEntry module 832) and stored in memory such as database 833. The Ticket module 831 also communicates with Notification module 834. The Notification module sends out notifications to users and service providers for important events on the serviced trouble ticket. Such events include service providers proposing answers, users marking the question as solved, etc. Module 825 receives tool button entries from the client and forwards them to tool manager module 835. In addition to managing the tool implementation (e.g., desktop sharing, file sharing, etc.), the Tool module 835 communicates information to the Ticket module 831 so that a ticket log entry can be made. Module 813 in the client 801 supplies the text and other information (e.g., URLs) entered in the messaging window to module 823. In addition to creating a transcript entry, module 823 also sends a message event to Ticket module so that a ticket log entry can be made. Because any interaction with the collaboration workspace window at the client indicates activity for the user/service provider at the client 801, that information is conveyed to User A Presentity 837 and to Ticket Presentity 839. Module 822 controls transcript loading at the client 801 (via Module 802). When a transcript is loaded, that information is conveyed to Ticket Presentity 839 as well.

Additional communications between the client 801 and server 802 occur via modules 817 and 826. Module 826 controls interaction between Watcher Manager 840, Watcher A module 843 and presentity modules for other users/service providers (e.g., User B Presentity 844). As described above, updated presentity information for users/service providers/and trouble tickets can be obtained and reported back to client 801 via module 807.

Resolving a request often requires collaboration by more than one provider, for example, because a mixture of skills or knowledge is required. However, when multiple providers collaborate, there is a risk that quality of service will drop because of confusion about who is ultimately responsible for resolving the request. To avoid this confusion, one provider can be designated as the primary provider, and the assisting providers are designated as secondary providers. The primary provider may have unique responsibilities and associated controls that ensure the request will be resolved efficiently and in a timely manner. Examples of unique primary provider controls are: to propose to the user that the request is resolved, to resolve the request (e.g., change the state of the user request to resolved), escalate the request service level to another service contract level (e.g., by changing the contract terms between the user and the service provider(s)), request collaboration from a secondary provider with a specific skill, request collaboration from a specific provider identified by name or E-mail, remove a secondary provider from collaborating on the user request, transfer primary provider responsibility to another provider (e.g., transfer “ownership” of the user request). When multiple providers are collaborating on the request, they may choose to communicate or share information that is visible to all collaborating providers and the user, or they may restrict that information to be visible to only providers, or only specific providers.

Referring to FIG. 8a, a block diagram showing the interrelationship between the primary and service providers is presented. In FIG. 8a, primary provider 901 initially has ownership of the trouble ticket 905 submitted by user 907. In one embodiment, the primary provider 901 can propose a role transfer for the trouble ticket 905. In this case, the secondary provider 903 can either accept or reject the role transfer (e.g., through messages via the service network platform). If the role is transferred than the second provider 903 becomes the primary service provider for the trouble ticket 905 and assumes all roles of the primary provider for that ticket (as described above). If necessary, the primary provider can cancel the role transfer.

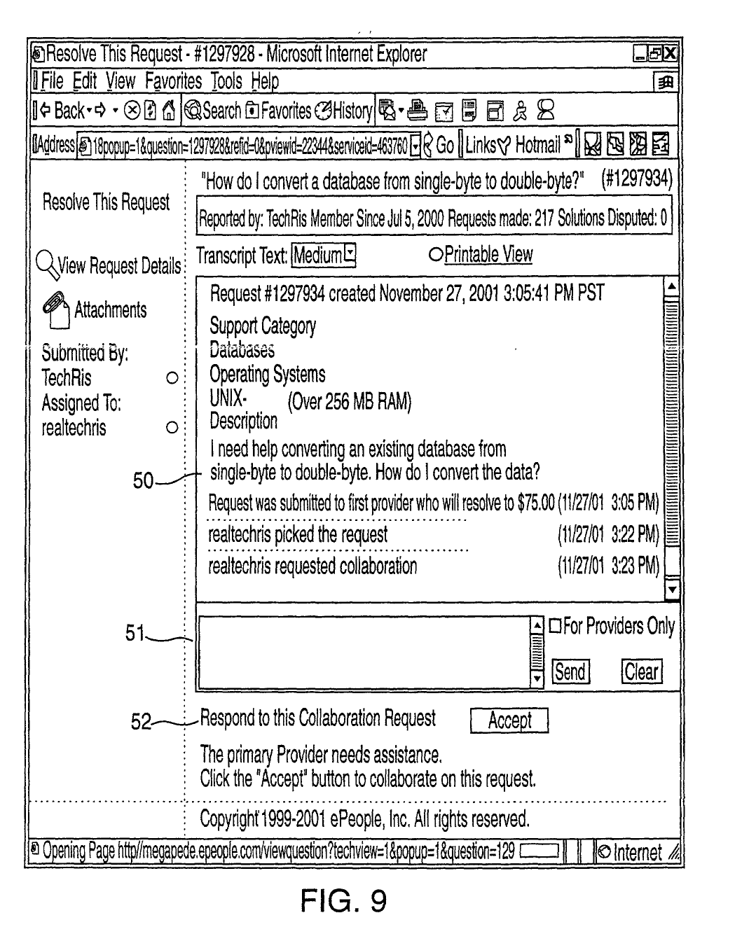

Referring to FIG. 9, an example of a display used for requesting collaboration on a user request is shown. In this embodiment, the primary service provider can make a collaboration request of a potential secondary service provider. For example, the “view details” button 225 (FIG. 3) can provide a display showing the details of the request entered by the user along with a button asking for collaboration. In this embodiment, the primary service provider has selected a particular secondary service provider who will access the display shown in FIG. 9. The display includes a description of the request 50, and entry area for comments 51, and a button 52 to accept the request and become a secondary service provider for the request.

The system may also include a set of configurable business rules that can configure and change aspects of the support process. For example, these aspects can include visibility of requests to different types of providers, service levels (e.g., the contract terms for servicing the request), whether collaboration is enabled, whether the primary provider can request collaboration by skill, name or E-mail, and how payment is provided for service. This configuration may be performed by an owner business manager at a service provider computer, who is responsible for managing support quality, cost, and similar support business goals. Different business rules may be configured depending on request classification, user identification, time, day, etc.

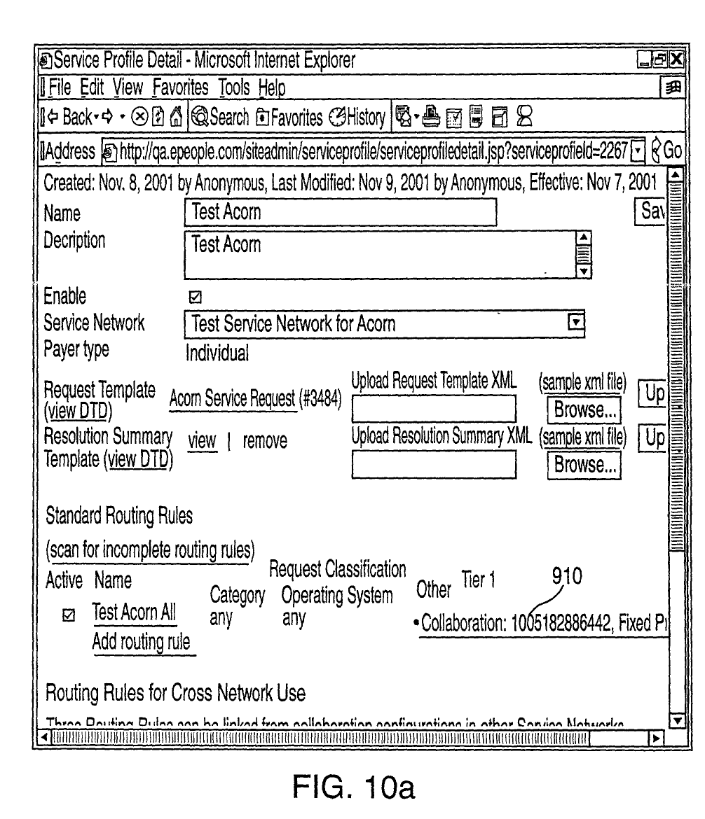

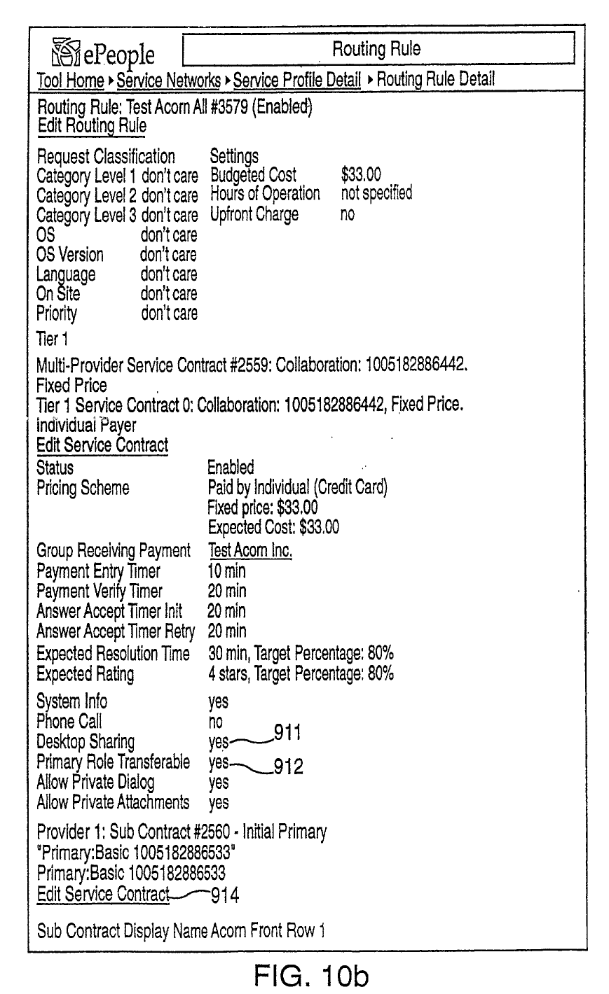

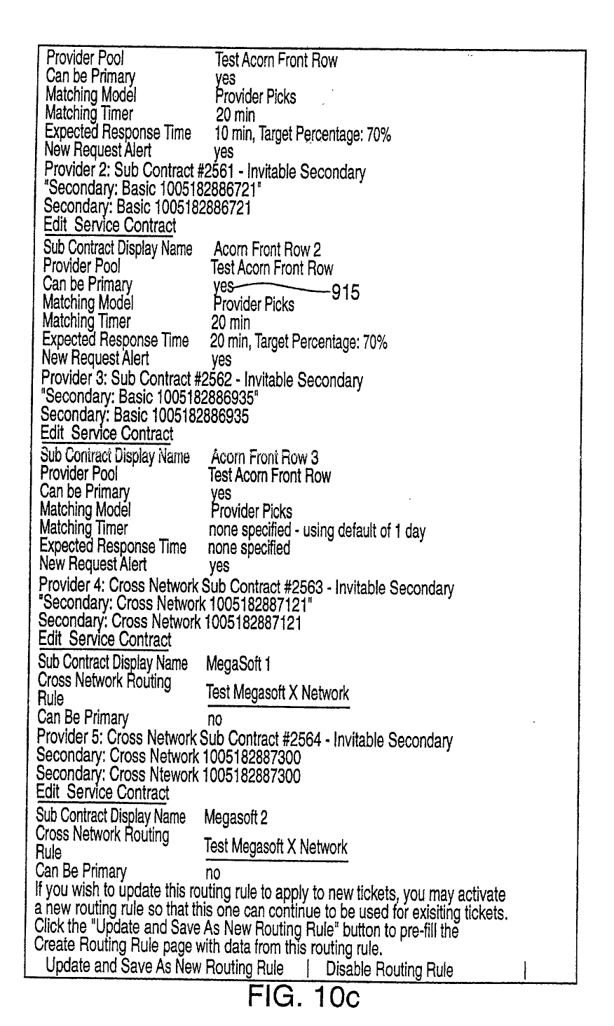

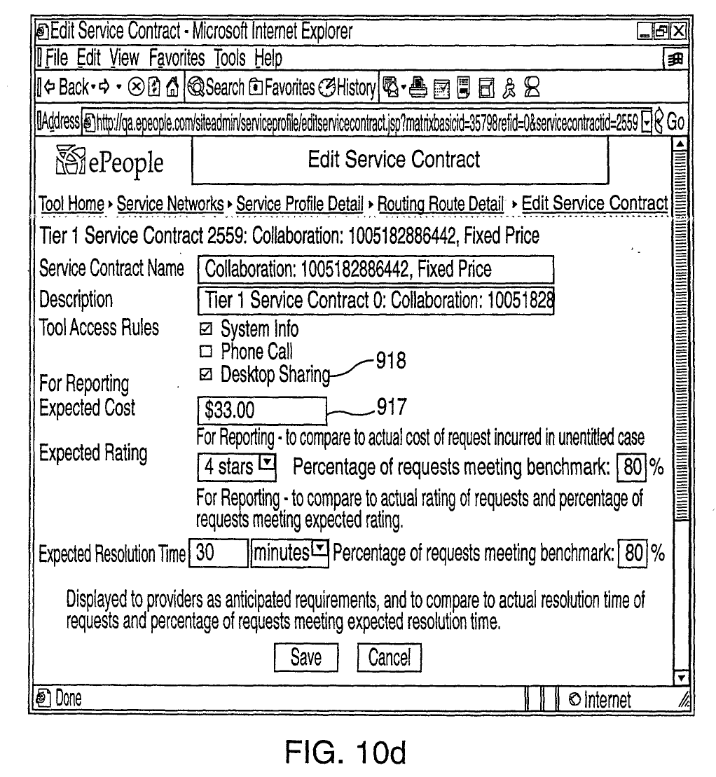

Referring to FIG. 10a, a sample screen for editing a service profile is shown. In this example, the user is able to review settings for servicing a particular customer (e.g., all products of a particular corporation). By selecting collaboration link 910, the user can then be transferred to screens shown in FIGS. 10b-c to change routing rules controlling collaboration of service providers for this service profile. As seen in FIG. 10b, the user can change a variety of items concerning service levels and the like. In particular, the user can control whether desktop sharing is enabled (911), whether primary service provider can transfer ownership to a secondary provider (912), etc. As shown in FIGS. 10b-c, features affecting individual service providers can be controlled as well. For example, as shown in FIG. 10c, the second provider in this service profile is allowed to receive ownership of an individual user request (e.g., can become a primary service provider)(915). In FIG. 10b, the user can edit the service contract for the first provider (914). The display of FIG. 10d is then shown. In FIG. 10d, aspects of the contract for the first provider can be changed, such as cost 917, desktop sharing (for that service provider)(918), etc.

Although several embodiments are specifically illustrated and described herein, it will be appreciated that modifications and variations of the present invention are covered by the above teachings and within the purview of the appended claims without departing from the spirit and intended scope of the invention. For example, though the description above concerns user requests related to computer hardware and software issues, the present invention can be extended to providing servicing of a variety of other types of user requests. Also, “user requests” can come from sources other than the user. For example, in this case, the user request can be generated in response to interaction between the user computer and the provider of the hardware/software, etc. product that is the subject of the user request.

What is claimed is:

1. A system for handling a user request comprising:
a first computer system associated with a user, the first computer system including a display unit to display a first window associated with the user request, the first computer system further adapted to transmit a message associated with the user request; and
a second computer system associated with a service provider; the second computer system including a display unit to display a second window associated with the user request, the second computer system further adapted to receive the message and display the message in the second window at the second computer system.

2. In a system including a first computer system associated with a user coupled to a second computer system associated with a service provider, a method of communication between the user and the service provider comprising:
providing a first window at the first computer system associated with a user request;
providing a second window at the second computer system associated with the user request;
transmitting a message associated with the user request from the first computer system to the second computer system;
displaying the message in the second window at the second computer system;
detecting status information for the user request; and
displaying the status information in the second window at the second computer system.

3. The method of claim 2 wherein said status information includes one of online, offline, and active.

4. A system for handling a user request comprising:
a central computer system adapted to be coupled to a first computer system associated with a user and to receive said user request from said first computer system; said central computer system further adapted to be coupled to a plurality of second computer systems, each associated with a service provider;
wherein said first and second computers are adapted to display first and second windows, respectively, associated with the user request and said central computer system is adapted to detect status information for the user request and display said status information in said first and second windows.

5. The system of claim 4, wherein said first and second computer systems are adapted to display messages associated with said user request in said first and second windows, respectively.

6. The system of claim 5, wherein one of said second computer systems is associated with a owner business manager and is adapted to control which of said messages are displayed on each of said second computer systems.

7. The system of claim 6, wherein control of which of said messages are displayed on each of said computer systems is based on a set of business rules.

8. The system of claim 4, wherein status information for said user request comprises a request state and said request state is one of opened/not assigned, assigned/not resolved, and resolved.

9. The system of claim 8, wherein said request state changes from assigned/not resolved to resolved when a proposed answer from one of the service providers is accepted by the user.

10. A method for handling a user request comprising:
transmitting a user request from a first computer system associated with a user to a central computer system;
assigning status information to said user request;
selecting said user request via a second computer system associated with a service provider;
providing a display window at each of said first and second computers; and
displaying the status information for the user request in said display windows.

11. The method of claim 10, wherein said selecting step further comprises
displaying said user request at said second computer system; and
displaying competitive offers for service of said user request.

12. The method of claim 10, wherein said selecting step further comprises:
displaying said user request at said second computer system; and
displaying a user priority for said user request.

13. A method for handling a user request comprising:
transmitting a user request from a first computer system associated with a user to a central computer system;
assigning status information to said user request;
providing said user request to a plurality of second computer systems, each associated with a service provider;
providing offers for service of said user request to the first computer system; and
displaying the status information for the user request and said offers at said first computer system.

14. The method of claim 13, further comprising:
displaying rating information for service providers associated with said offers at said first computer system; and
selecting one of said offers at said first computer system.

15. The method of claim 14, further comprising:
displaying presence information for service providers associated with said offers at said first computer system; and
selecting one of said offers at said first computer system.

16. A method for handling a user request comprising:
transmitting a user request from a first computer system associated with a user to a central computer system;
assigning status information to said user request;
selecting said user request via a second computer system associated with a primary service provider;
providing a display window at each of said first and second computers;
displaying the status information for the user request in said display windows;
transmitting a collaboration request from said second computer system to a third computer system associated with a secondary service provider; and
accepting said collaboration request at said third computer system wherein said first, second, and third computer systems are adapted to display messages associated with said user request.

17. The method of claim 16 wherein on said primary and secondary service providers has ownership of said user request, the method further comprising:
transferring ownership of said user request between said primary and secondary service providers.
